(19) United States
(12) Patent Application Publication
(10) Pub. No.: US 2013/0311397 A1
(43) Pub. Date: Nov. 21, 2013

(54) SYSTEMS AND METHODS FOR FINANCIAL STOCK SCREENING THAT INCORPORATES PATENT DATA

(71) Applicants: MAULIN SHAH, New York, NY (US); SAMIR DEEPAK NAIK, San Francisco, CA (US); ANJALI JINDAL NAIK, San Francisco, CA (US); THOMAS TRAN, San Francisco, CA (US); JONATHAN CHAO, San Francisco, CA (US)

(72) Inventors: MAULIN SHAH, New York, NY (US); SAMIR DEEPAK NAIK, San Francisco, CA (US); ANJALI JINDAL NAIK, San Francisco, CA (US); THOMAS TRAN, San Francisco, CA (US); JONATHAN CHAO, San Francisco, CA (US)

(21) Appl. No.: 13/589,102

(22) Filed: Aug. 18, 2012

Related U.S. Application Data
(60) Provisional application No. 61/648,201, filed on May 17, 2012.

(51) Int. Cl. G06Q 40/06; G06F 17/30

(52) U.S. Cl. 705/36 R

(57) ABSTRACT

The present invention provides means for screening investments by correlating financial information and patent information using customized criteria. Specifically, the present invention provides a screening tool that identifies publicly traded companies based on financial criteria input by a user, and further filters the publicly traded companies based on patent criteria input by the user.

### CROSS-REFERENCE TO RELATED APPLICATIONS

The present application claims the benefit of U.S. Provisional patent application No. 61/648,201, filed on May 17, 2012, the contents of which is hereby incorporated by reference in its entirety.

### BACKGROUND

1. Field of the Invention

The present invention relates generally to the field of interactive stock screening tools, and more specifically, to tools which incorporate patent data as a screening metric.

2. Description of Related Art

Financial and investing screeners allow investors to specify various criteria, such as industry, market capitalization, earnings, etc. in order to receive a filtered list of investment options that meet the user's criteria. Current screeners do not offer the ability to include non-financial related criteria, such as patent data.

With the increasing importance companies are placing on intellectual property and the procurement and enforcement of patent rights, the size, value, and strength of a company's patent portfolio is an important factor when considering the overall value of a company.

Thus, there currently exists a need for an investment screener that allows users to input financial criteria as well as patent-related criteria in order to receive a filtered list of investment options.

### SUMMARY

In an embodiment, the present invention relates to a method for screening investments based on financial information and patent data, comprising the steps of: receiving, at a query interface coupled to a query server, at least one non-patent criteria; receiving, at the query interface, at least one patent criteria; transmitting the non-patent criteria and the patent criteria to the query server from the query interface; transmitting a query containing only the non-patent criteria to a first database from the query server; receiving a non-patent result set at the query server from the first database; transmitting the non-patent result set to a second database from the query server; generating a patent result set by the second database based on the non-patent result set; receiving the patent result set at the query server from the second database; combining the patent result set and the non-patent result set by the query server; and transmitting the combined patent result set and the non-patent result set to a result interface from the query server.

In another embodiment, the present invention relates to a method of screening stocks using patent data, the method comprising the steps of: receiving at a query server from a client device at least one of patent criteria, the patent criteria selected from a group consisting of a patent portfolio size, an average number of cited patents count, an average number of citing patents count, an issuance percentage, and a litigation percentage; receiving at the query server from the client device at least one financial criteria; retrieving, by the query server, financial records matching the financial criteria from a financial database; extracting, by the query server, a company name from the records retrieved from the financial database; retrieving, by the query server, patent records matching the patent criteria from a patent database; and filtering, by the query server, the patent records by the company name.

In yet another embodiment, the present invention relates to a system for screening stocks using patent data, comprising: an interface comprising: at least one input field for a financial criteria; and at least one input field for a patent criteria, where the patent criteria is selected from a group consisting of a patent portfolio size, an average number of cited patents count, an average number of citing patents count, an issuance percentage, and a litigation percentage.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a block diagram of a network architecture in an embodiment of the present invention;

FIG. 2 is a flowchart illustrating the steps taken by an embodiment of the present invention;

FIG. 3 is a screen layout of the query interface in an embodiment of the present invention; and

FIG. 4 is a screen layout of the results interface in an embodiment of the present invention.

### DETAILED DESCRIPTION

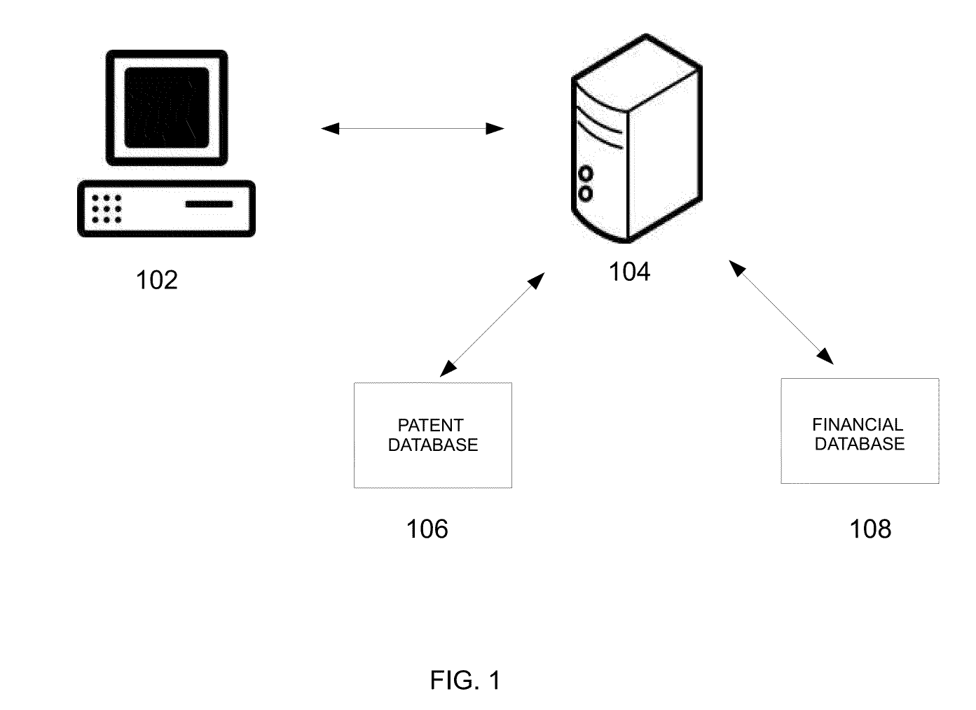

FIG. 1 is a block diagram of a network architecture in an embodiment of the present invention. User device 102 can be any computing device capable of connectivity to a network, such as a desktop computer, laptop computer, netbook, smartphone, tablet computer, or an internet-capable television. User device 102 is coupled, via a communication network, to a query server 104. The query server 104 is located remotely from the user device 102, such that the user device 102 accesses the query server 104 via the communication network. In an alternative embodiment, the query server 102 can be downloaded or installed locally on the user device 102.

The query server 104 is communicatively coupled to at least one database source, such as a patent database 106 and/or a financial database 108. The patent database 106 can include more than one third-party databases that compile and organize patent data, such as, but not limited to, Thomson Innovation, the USPTO public database, Lexis-Nexis TotalPatent, and the Espacenet at the European Patent Office. In an embodiment, the patent database 106 is a single database that has imported data from at least one third-party patent database.

The financial database 108 can include more than one third-party databases the compile and organize financial data, such as form, but not limited to, Thomson Reuters and Morningstar. In an embodiment, the financial database 108 is a single database that has imported data from at least one third-party patent database.

In another embodiment, the patent database 106 and the financial database 108 are combined into a single database that is utilized by the query server 104.

In an embodiment, the patent database 106 and the financial databases 108 are updated and/or refreshed with data from various third-party databases. The updates can happen on a pre-determined duration, such as in real-time, on an hourly basis, a daily basis, and/or a weekly basis.

Upon receiving a user query through the user device 102, the query is transmitted to the query server 104. The query server 104 parses the query, and searches the patent database 106 and the financial database 108. The query server 104 retrieves all relevant records from the patent database 106 and the financial database 108, and combines the retrieved records for display on the user device 102, as described in more detail below.

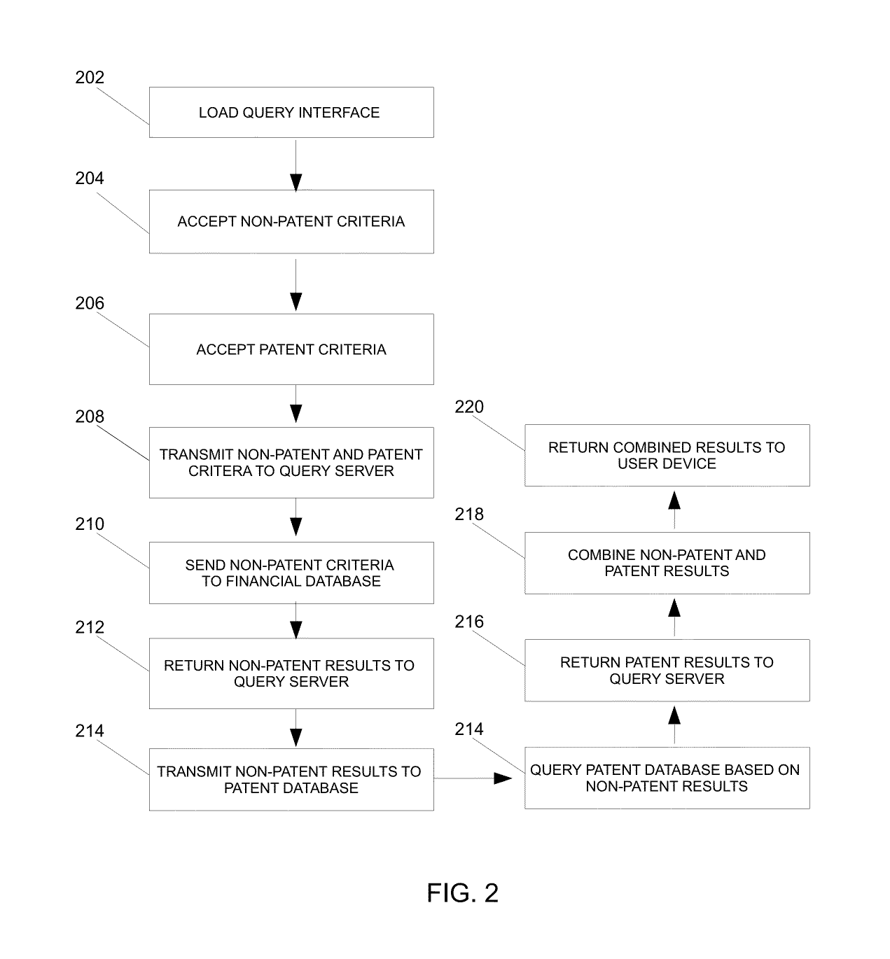

FIG. 2 is a flowchart illustrating the steps taken by an embodiment of the present invention. In step 202, a query interface is loaded on the user device 102. The user interface can be accessible through a website via an Internet browser, such as Mozilla Firefox or Internet Explorer. A unique URL, such as “http://www.patentwire.com” is used access the query interface. In an embodiment, prior to accessing website with the query interface, a username and/or password is required, and a subscription may also be required. Upon entering the website, the query interface is loaded.

In another embodiment, the query interface can be accessed via a desktop application that has been installed or downloaded locally on the user device 102.

Next, in step 204, the user enters various non-patent criteria. The non-patent criteria can include stock information such as, but not limited to, stock price, market capitalization, dividend yield, beta (i.e., volatility), short interest, financial information such as sales revenue and profit margin, valuation rations such as price-to-earnings (P/E) ratio, price-to-book (P/B) ratio, price to-sales (P/S) ratio, and price/earnings-to-growth (PEG) ratio, and performance criteria such as performance versus an index and industry.

In an embodiment, the query interface can include at least one or all, and any combination thereof, of any of the aforementioned non-patent criteria and metrics. In addition, the present invention is not limited to using only the non-patent criteria described herein, and any non-patent criteria well known to one skilled in the art can be utilized by the present invention.

Next, in step 206, the user enters various patent criteria, such as, but not limited to, patent portfolio size, average remaining term of the patent portfolio, number of pending patent applications, average number of citing patents, average number of cited patents, patent issuance rate, and percent of patent portfolio litigated. In addition, users can select patent data for a specific country, such as the United States, or multiple countries, or aggregate worldwide patent data.

In an embodiment, the query interface can include at least one or all, and any combination thereof, of any of the aforementioned patent criteria and metrics. In addition, the present invention is not limited to using only the patent criteria described herein, and any patent criteria well known to one skilled in the art can be utilized by the present invention.

In step 208, the query criteria is transmitted from the user interface or user device to the query server 104. The query server 104 parses the query criteria, and in step 208, transmits the patent criteria to the patent database 106, and transmits the non-patent criteria to the financial database 108. As mentioned above, the patent database 106 and the financial database 108 can be a single combined database as well.

In step 210, the query server 104 transmits the non-patent criteria to the financial database 108 to determine the company names that meets the non-patent criteria. For example, if the user selected only large market capitalization telecommunications stocks, then the financial database 108 would return the company names of telecommunications companies with a market capitalization of $10 billion or more.

Next in step 212, these identified company names and the corresponding financial information (i.e., stock information, financial information, valuation ratios, and/or performance data) are transmitted to the query server 104. In step 214, the query server 104 transmits the company names to the patent database 106.

In step 216, for each of the received company names, the patent database 106 retrieves patent data records where the “assignee” or “reassignment assignee” fields matches a company name, and removes records where the “reassignment assignor” matches the company name. Step 216 is repeated until each of the received company names have been queried against the patent database assignee records and reassignment assignee fields.

In step 218, the query server 104 receives the patent data from the patent database 106 that corresponds to the company names identified by the financial database 108. This patent data includes, but is not limited to, patent portfolio size, average remaining term of the patent portfolio, number of pending patent applications, average number of citing patents, average number of cited patents, patent issuance rate, and percent of patent portfolio litigated. The query server 104 combines all of the retrieved data, and in step 220, the query server 104 transmits the query results to the user device 104.

In another embodiment, the query server 104 can first access the patent database 106 to determine assignee and/or reassignment assignee records matching the patent criteria. The identified assignee and/or reassignment assignee names are then transmitted to the query server 104, which then queries the financial database 108 for financial data matching company names equal to the assignee and/or reassignment names.

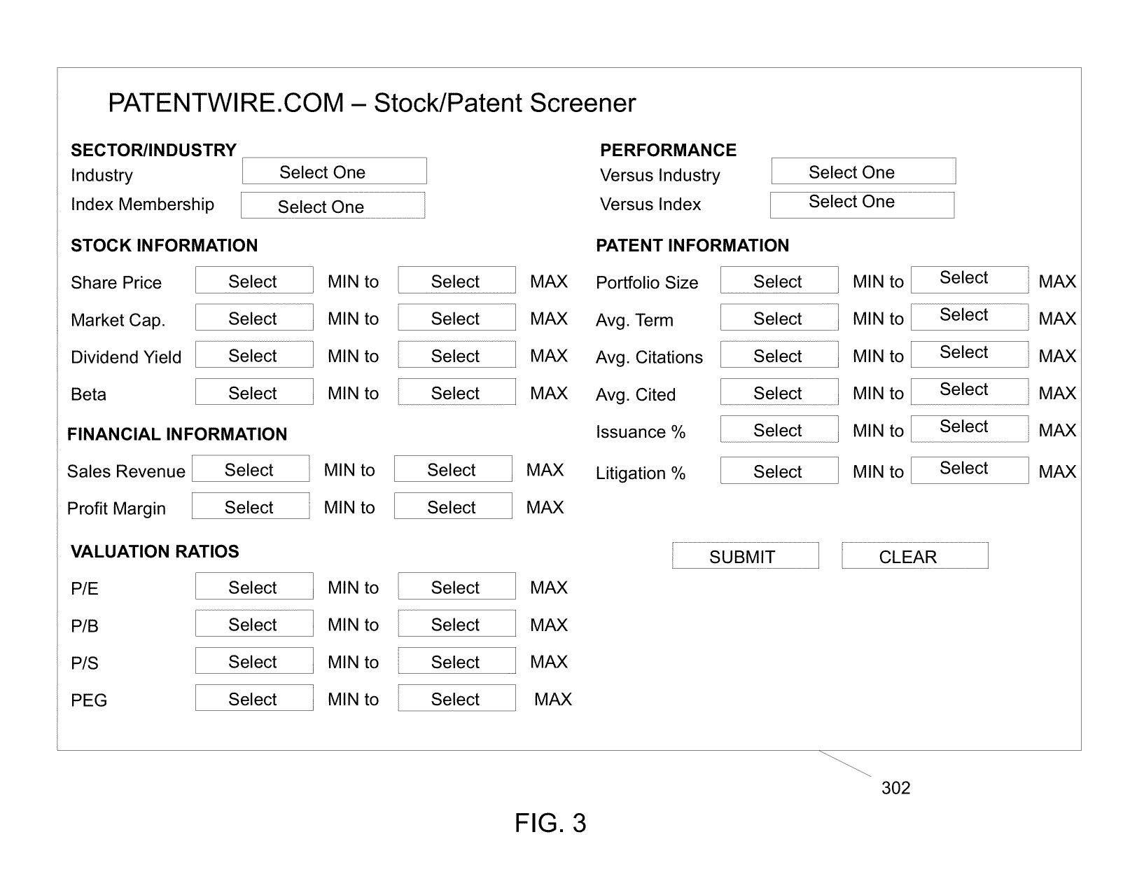

FIG. 3 is a screen layout of the query interface in an embodiment of the present invention. The query interface 302 includes patent criteria and non-patent criteria. The fields shown in the query interface 302 are exemplary, and the present invention can include any combination of fields and sub-fields. In the event that a field is left blank, the query server 104 will not include that field in its query processing, and will not include the blank fields as a variable that is passed to the patent and/or financial databases.

In an embodiment, the fields and sub-fields include drop-down selection fields. The query interface 302 can include other types of input fields, such as text boxes, radio buttons, check boxes, and/or number picker popup (similar to a calendar popup), and any combinations thereof.

In an embodiment, a user must select at least one field or sub-field from the “Patent Information” criteria and at least one field or sub-field from the remaining non-patent criteria. If at least one field or sub-field from each category is not selected, the user will be prompted to make such a selection before the query is transmitted to the query server.

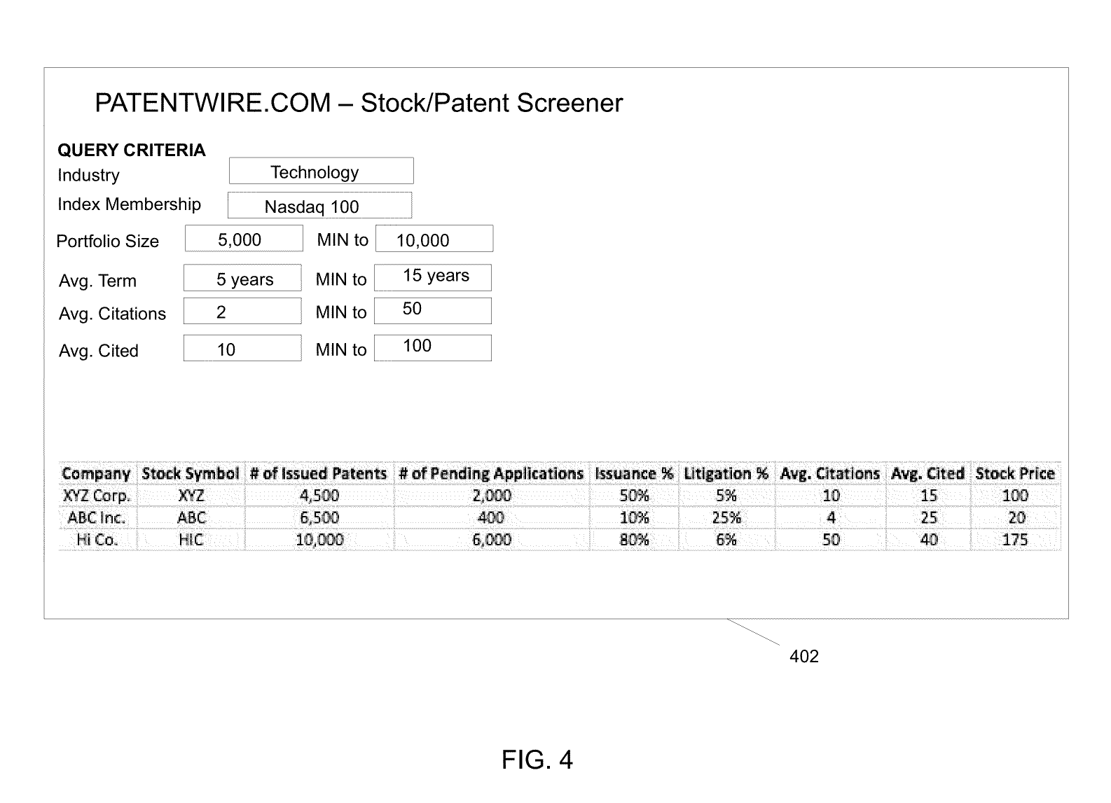

FIG. 4 is a screen layout of the results interface in an embodiment of the present invention. The results interface 402 displays the user criteria entered on the query interface 302, as well as the matching companies that met the query criteria. The results can be hyperlinked, so that, for example, the user can click on the “# of Issued Patents” field, and a pop-up window (or a new browser tab or window) appears with a list of all of the patents and their corresponding bibliographic information and/or full-text details.

In another embodiment, the user can select multiple resulting companies, and various comparison metrics can be displayed. For example, the patent and/or financial data for multiple selected companies can be overlaid together. In an example, a user can view the issued patent and/or patent application filing history for multiple companies, along with stock price, on the same visual graph.

In an embodiment, the query server 104 or the patent database 106 calculates the average remaining term of a company's patent portfolio by, for each patent in a company's patent portfolio, subtracting the current year by the priority year, summing each resulting year value, and dividing the sum by the total number of patents in the company's patent portfolio.

The query server 104 or the patent database 106 calculates the average cited patent count (i.e., backward citations) by, for each patent in a company's patent portfolio, summing the number of patent and non-patent citations, and dividing by the total number of patents in the company's patent portfolio. The present invention uses the average cited patent count as an indicator of patent portfolio's strength, where a higher number of citations indicates that a patent has undergone a more extensive review by the patent office during prosecution of the underlying patent application.

The query server 104 or the patent database 106 calculates the average citing patent count (i.e., forward citations) by, for each patent in a company's patent portfolio, summing the number of patent cites, or the number of later issued patents that cite to that particular patent, and dividing by the total number of patents in the company's patent portfolio. The present invention uses the average citing patent count as an indicator of a how fundamental the technology in a patent portfolio is. A larger average citing patent count indicates that a company's peers and/or competitors have cited to that company's patents, suggesting that the cited company is a pioneer in its field as far as patenting core technologies.

The query server 104 or the patent database 106 calculates the issuance percentage of a company's patent portfolio by dividing the number of issued patents by the total number of patent applications. The present invention uses the issuance percentage as an indicator as to how selective a company is in filing patents. A lower issuance percentage indicates that a company files patent applications on technology that may not necessarily be novel, and thus, resulting in a high rate of rejections. A higher issuance percentage indicates that a company selectively files patent applications on novel technologies.

In another embodiment, the results are displayed on the results interface 402 in graphical format, and the user can manipulate and interact with the resulting data. For example, various charts, graphs, and maps can be displayed that incorporate patent and financial data related to the resulting company data. The results can be exported to various formats (PDF, image files, etc.), as well as shared via email, Twitter, and/or social media posting.

In an embodiment, depending on a user's subscription level, various querying, viewing, manipulation/interaction, and exporting features can be selectively enabled and/or disabled. Furthermore, such features can be accessed on a pay-per-use basis.

While the principles of the disclosure have been illustrated in relation to the exemplary embodiments shown herein, the principles of the disclosure are not limited thereto and include any modification, variation or permutation thereof.

What is claimed is:

1. A method for screening investments based on financial information and patent data, comprising the steps of:
receiving, at a query interface coupled to a query server, at least one non-patent criteria;
receiving, at the query interface, at least one patent criteria;
transmitting the non-patent criteria and the patent criteria to the query server from the query interface;
transmitting a query containing only the non-patent criteria to a first database from the query server;
receiving a non-patent result set at the query server from the first database;
transmitting the non-patent result set to a second database from the query server;
generating a patent result set by the second database based on the non-patent result set;
receiving the patent result set at the query server from the second database;
combining the patent result set and the non-patent result set by the query server; and
transmitting the combined patent result set and the non-patent result set to a result interface from the query server.

2. The method of claim 1, wherein the first database and the second database are combined within a single database entity.

3. The method of claim 1, wherein in the first database contains only non-patent data.

4. The method of claim 1, wherein the second database contains only patent data.

5. The method of claim 1, further comprising the step of matching a company name generated by the first database to an assignee field in the second database by the query server.

6. The method of claim 1, wherein the query server is located remote from the query interface.

7. A method of screening stocks using patent data, the method comprising the steps of:
receiving at a query server from a client device at least one patent criteria, the patent criteria selected from a group consisting of a patent portfolio size, an average number of cited patents count, an average number of citing patents count, an issuance percentage, and a litigation percentage;
receiving at the query server from the client device at least one financial criteria;
retrieving, by the query server, financial records matching the financial criteria from a financial database;
extracting, by the query server, a company name from the financial records retrieved from the financial database;
retrieving, by the query server, patent records matching the patent criteria from a patent database; and
filtering, by the query server, the patent records by the company name.

8. The method of claim 7, wherein the patent database and the financial database are combined within a single database entity.

9. The method of claim 7, wherein the patent criteria is a single data point.

10. The method of claim 7, wherein the patent criteria is a range of values including a minimum value and a maximum value.

11. The method of claim 7, further comprising the step of displaying at the client device at least one financial information and at least one patent information selected from a group consisting of a patent portfolio size, an average number of cited patents count, an average number of citing patents count, an issuance percentage, and a litigation percentage.

12. The method of claim 7, wherein retrieving patent records matching the patent criteria from the patent database comprises matching the company name to an assignee field in the patent database.

13. The method of claim 7, wherein retrieving patent records matching the patent criteria from the patent database comprises matching the company name to a reassignment assignee field in the patent database.

14. A system for screening stocks using patent data, comprising:
an interface comprising:
at least one input field for a financial criteria; and
at least one input field for a patent criteria, where the patent criteria is selected from a group consisting of a patent portfolio size, an average number of cited patents count, an average number of citing patents count, an issuance percentage, a short interest, and a litigation percentage.

15. The system of claim 14, wherein the patent criteria is a range of values including a minimum value and a maximum value.

16. The system of claim 14, wherein the financial criteria is selected from a group consisting of an industry type, an index membership, a sector type, and a market capitalization.

17. The system of claim 14, wherein the financial criteria is selected from a group consisting of a price-to-earnings ratio, a price-to-book ratio, a price-to-sales ratio, and a price/earnings-to-growth ratio.

18. The system of claim 14, wherein the interface is accessible via an Internet web browser.

19. The system of claim 14, wherein the interface is accessible via a desktop application.

20. The system of claim 14, wherein the interface is accessible via a mobile device.
